(19) United States
(12) Patent Application Publication
(10) Pub. No.: US 2026/0127095 A1
(43) Pub. Date: May 7, 2026

(54) MINIMIZING CARBON FOOTPRINT DURING LIFECYCLE

(71) Applicant: Kyndryl, Inc., New York, NY (US)

(72) Inventors: Sasikala Palanisamy, Chennai (IN); Praveen Kumar Madhava Rao, Brno (CZ); Kavitha Suresh Kumar, Bangalore (IN); Pedro Soares, Silveira (PT); Vidyasree Bharathwaj, Chennai (IN)

(21) Appl. No.: 18/934,665

(22) Filed: Nov. 1, 2024

(51) Int. Cl. G06F 11/36

(52) U.S. Cl. CPC G06F 11/3636

(57) ABSTRACT

Embodiments receive a plurality of code change inputs; determine that the plurality of code change inputs are similar to data in a first artificial intelligence (AI) model; classify the plurality of code change inputs using a second AI model; identify at least one pipeline stage that needs to be executed and at least one pipeline stage that does not need to be executed; determine that the identified at least one pipeline stage needs to be executed based on contextual data; execute the identified at least one pipeline stage that needs to be executed; and prevent execution of the identified at least one pipeline stage that does not need to be executed.

### BACKGROUND

Aspects of the present invention relate generally to minimizing a carbon footprint during a lifecycle and, more particularly, to systems and methods for minimizing the carbon footprint during a software development lifecycle pipeline.

Information technology and software automation is a business driver for any enterprise organization. Accordingly, software industries implement dynamic business requirements through continuous integration and deployment.

### SUMMARY

In a first aspect of the invention, there is a computer-implemented method including: receiving, by a computing device, a plurality of code change inputs; determining, by the computing device, that the plurality of code change inputs are similar to data in a first artificial intelligence (AI) model; classifying, by the computing device, the plurality of code change inputs using a second AI model; identifying, by the computing device, at least one pipeline stage that needs to be executed and at least one pipeline stage that does not need to be executed; determining, by the computing device, that the identified at least one pipeline stage needs to be executed based on contextual data; executing, by the computing device, the identified at least one pipeline stage that needs to be executed; and preventing executing, by the computing device, the identified at least one pipeline stage that does not need to be executed.

In another aspect of the invention, there is a computer program product including one or more computer readable storage media having program instructions collectively stored on the one or more computer readable storage media. The program instructions are executable to: receive a plurality of code change inputs; determine that the plurality of code change inputs are not similar to data in a first artificial intelligence (AI) model; identify at least one pipeline stage that needs to be executed and at least one pipeline stage that does not need to be executed; determine that the identified at least one pipeline stage needs to be executed based on contextual data; execute the identified at least one pipeline stage that needs to be executed; and prevent execution of the identified at least one pipeline stage that does not need to be executed.

In another aspect of the invention, there is a system including a processor, a computer readable memory, one or more computer readable storage media, and program instructions collectively stored on the one or more computer readable storage media. The program instructions are executable to: receive a plurality of code change inputs; determine that the plurality of code change inputs are similar to data in a first artificial intelligence (AI) model; classify the plurality of code change inputs using a second AI model; identify at least one pipeline stage that needs to be executed and at least one pipeline stage that does not need to be executed; determine that the identified at least one pipeline stage needs to be executed based on contextual data; execute the identified at least one pipeline stage that needs to be executed; and preventing execution of the identified at least one pipeline stage that does not need to be executed.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a carbon footprint ecovision system in accordance with aspects of the present invention.

FIG. 5 shows a block diagram of a rules inspection and an artificial intelligence (AI) model in accordance with aspects of the present invention.

FIG. 6 shows an example of a pipeline of the carbon footprint ecovision system in accordance with aspects of the present invention.

FIG. 7 shows a flowchart of an exemplary method of the carbon footprint ecovision system in accordance with aspects of the present invention.

FIG. 8 shows another flowchart of an exemplary method of the carbon footprint ecovision system in accordance with aspects of the present invention.

### DETAILED DESCRIPTION

Aspects of the present invention relate generally to minimizing a carbon footprint during a lifecycle and, more particularly, to systems and methods for minimizing the carbon footprint during a software development lifecycle pipeline. Aspects of the present invention may be implemented as a system, method, or computer program product. The system, method, or computer program product optimizes energy consumption and minimizes the carbon footprint by eliminating energy wastage in a software development lifecycle during a development security operation (i.e., DevSecOp) continuous integration/continuous development (CI/CD) pipeline. In addition, the system, method, or computer program product analyzes and optimizes the DevSecOp CI/CD pipeline execution to curtail energy consumption. The system, method, and/or computer program product eliminates carbon emission wastage to conserve energy consumption. Accordingly, the system, method, and/or computer program product analyzes, identifies, and eliminates non-essential compute cycles during a software development lifecycle through the DevSecOp CI/CD pipeline to save resources, energy, costs, and environmental hazards. The systems and methods provided herein may be computer implemented methods.

More specifically, the system, method, or computer program product described herein performs analysis, feedback learning assistance, and sustainable execution routines. The system, method, or computer program product drives environmental sustainability by significantly reducing carbon footprint throughout various stages of a software development lifecycle, which plays a critical role in dynamic continuous integration and development and satisfying business requirements. Further, the system, method, or computer program product minimizes energy wastage during the software development lifecycle towards a net zero objective. In further embodiments, the system, method, or computer program product prioritizes sustainability by seamlessly integrating the DevSecOp pipeline to identify and eliminate redundant pipeline stages in real-time, thereby curbing energy wastage. Embodiments of the present invention analyze, identify, and eliminate non-essential compute cycles during the software development lifecycle through the DevSecOp CI/CD pipeline through a rule-based and artificial intelligence (AI) powered approach based on the context and the pipeline condition to save resources, energy, cost, and environmental hazards. Further, embodiments of the present invention utilize a rule-based approach to improve decision making and an artificial intelligence (AI)/machine learning (ML) model to improve decisions on indefinite/definite patterns and utilize learning assistance feed contextual data for continuous learning.

Aspects of the present invention analyze and identify required pipeline stages in a development operations (DevOps) pipeline based on a code change. Embodiments of the present invention skip unwanted stages based on the code change. Further, embodiments of the present invention measure and estimate a carbon footprint and energy saved by skipping the unwanted stages.

Embodiments of the present invention provide a computer-implemented method, a system, and a computer program product to drive environmental sustainability for reducing a carbon footprint in a software development life cycle, especially in the DevOp/DevSecOp pipeline by implementing ecostudy, ecoflow, and ecorun modules. In aspects of the present invention, the computer-implemented method, the system, and the computer program product analyzes and identifies the required pipeline stage and provide an optional workflow using a feedback driven learning assistance using artificial intelligence (AI)/machine learning (ML). In further embodiments of the present invention, the computer-implemented method, the system, and the computer program product executes required stages corresponding to code changes and generates an environmental, social, and governance (ESG) score and energy savings.

In contrast, known systems perform continuous execution of an entire CI/CD pipeline for each code change without regards to optimization of the CI/CD pipeline and minimize carbon emissions during the software development lifecycle. Further, known systems merely attempt to reduce carbon emissions in software development through optimizing workload placement, providing code recommendations, and monitoring pipelines. However, known systems are not able to analyze and optimize the pipeline execution to curtail energy consumption. Further, known systems result in unnecessary energy consumption, and do not optimize energy consumption or minimize a carbon footprint by eliminating energy wastage in pipeline execution during a software development lifecycle. The systems, methods, and computer program products as described herein make improvements on known systems by enabling the present invention to analyze, identify, and eliminate non-essential compute cycles during the software development lifecycle through optimization of pipeline execution to save resources, energy, costs, and environmental hazards.

Implementations of the present invention are also rooted in computer technology. For example, the steps of training, by a computing device, a first artificial intelligence (AI) model based on a plurality of code change inputs to classify and analyze code changes, and training, by the computing device, a second AI model based on historical data for previous pipeline executions, previous code changes, and previous decisions to output an optimized pipeline execution are computer-based and cannot be performed in the human mind. For example, training the first AI model based on the plurality of code changes inputs to classify and analyze code and training the second AI model based on historical data to output an optimized pipeline execution are by definition, performed by a computer and cannot practically be performed in the human mind (or with pen and paper) due to the complexity and massive amounts of calculations involved. Given the scale and complexity of training the first and second AI models, it is simply not possible for the human mind, or for a person using pen and paper, to perform the number of calculations involved in outputting an optimized pipeline execution in real-time, amongst other features described herein that are also root in computer technology.

It should be understood that, to the extent implementations of the invention collect, store, or employ personal information provided by, or obtained from, individuals (for example, user review of code changes), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

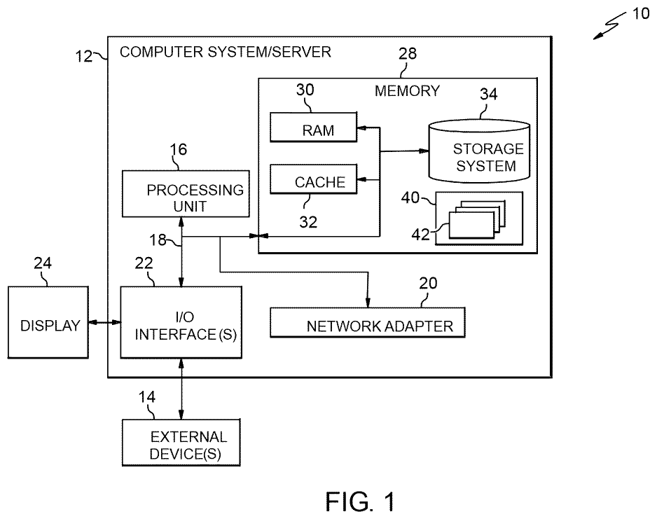

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

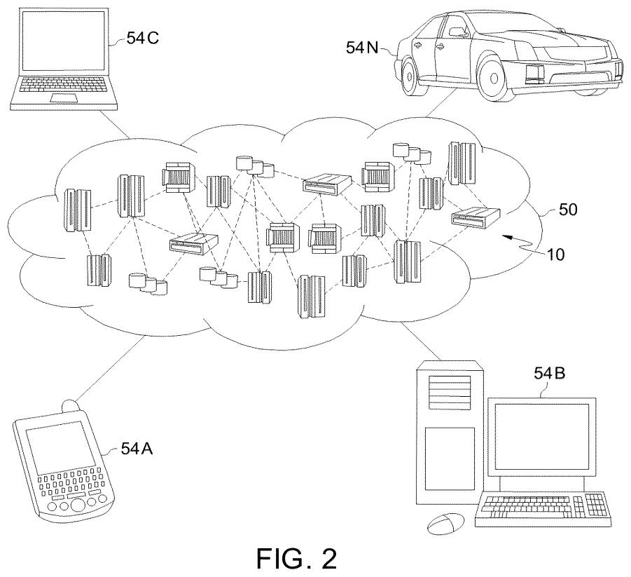

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

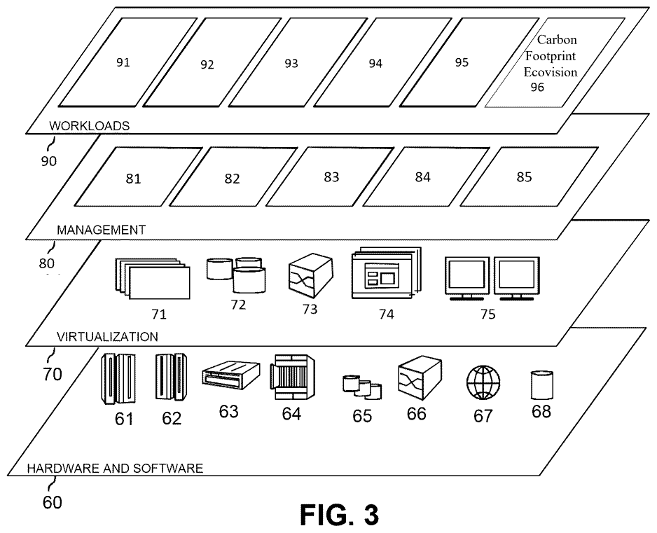

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and carbon footprint ecovision 96.

Implementations of the invention may include a computer system/server 12 of FIG. 1 in which one or more of the program modules 42 are configured to perform (or cause the computer system/server 12 to perform) one of more functions of the carbon footprint ecovision 96 of FIG. 3. For example, the one or more of the program modules 42 of the carbon footprint ecovision 96 may be configured to: receive a plurality of code change inputs; determine that the plurality of code change inputs are similar to data in a first artificial intelligence (AI) model; classify the plurality of code change inputs using a second AI model; identify at least one pipeline stage that needs to be executed and at least one pipeline stage that does not need to be executed; determine that the at least one pipeline stage needs to be executed based on contextual data; execute the identified at least one pipeline stage; and prevent execution of the identified at least one pipeline stage that does not need to be executed.

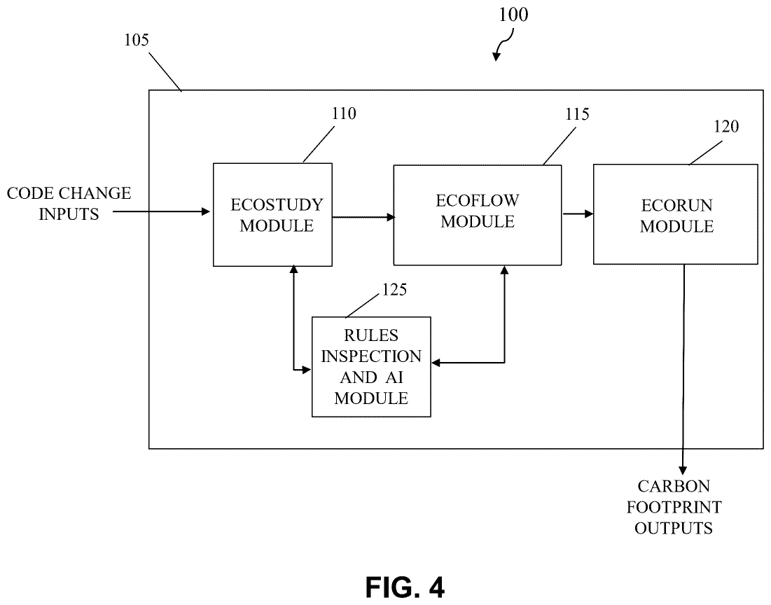

FIG. 4 shows a block diagram of a carbon footprint ecovision system in accordance with aspects of the invention. In embodiments, the carbon footprint ecovision system 100 comprises a carbon footprint ecovision environment 105 which includes an ecostudy module 110, an ecoflow module 115, an ecorun module 120, and a rules inspection and artificial intelligence (AI) module 125, each of which may comprise one or more program modules such as program modules 42 described with respect to FIG. 1 and the carbon footprint ecovision 96 of FIG. 3.

The carbon footprint ecovision system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the carbon footprint ecovision system 100 enables the system, method, and computer-program product to analyze, identify, and eliminate non-essential compute cycles of a pipeline during a software development life cycle to save resources, energy, cost, and environmental hazards. In particular, the carbon footprint ecovision system 100 is integrated in the pipeline (e.g., CI/CD pipeline) such that the carbon footprint ecovision system 100 analyzes the code change inputs, identifies pipeline stages that need to be executed, and skips remaining pipeline stages that are unnecessary to save energy consumption and reduce the carbon footprint. In other embodiments, the carbon footprint ecovision system 100 executes all pipeline stages based on the code change inputs. For example, the carbon footprint ecovision system 100 may execute all pipeline stages in response to the code change inputs having a high priority or having a high criticality to the carbon footprint ecovision system 100.

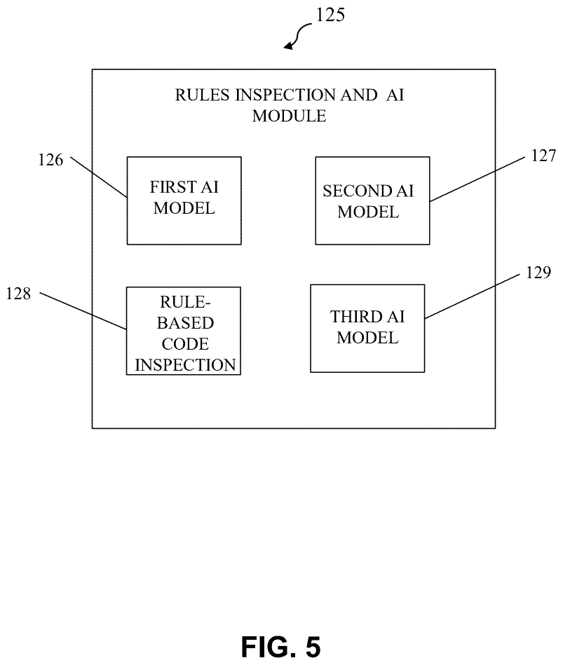

In further embodiments, the ecostudy module 110 receives a plurality of code change inputs and analyzes the plurality of code changes to identify the pipeline stages that need to be executed based on the plurality of code changes. In aspects of the present invention, the ecostudy module 110 automatically receives the plurality of code change inputs based on a software developer making code changes and initiating a code pull request. In particular, the ecostudy module 110 analyzes the plurality of code changes based on a plurality of factors. For example, the ecostudy module 110 communicates with the rules inspection and AI module 125 to determine whether a first artificial intelligence (AI) model has been trained with data that is similar to the plurality of code changes inputs. In this situation, the ecostudy module 110 determines that a first AI model 126 (as shown in FIG. 5) has been trained with data that is similar to the plurality of code change inputs in response to the plurality of code change inputs being within a predetermined threshold similarity to the data of the first AI model 126. In further embodiments, the predetermined threshold similarity represents a percentage of code similarity between the data the plurality of code change inputs.

In aspects of the present invention, the ecostudy module 110 utilizes a rule-based code inspection 128 (as shown in FIG. 5) within the rules inspection and AI module 125 in response to the plurality of code changes inputs not being within the predetermined similarity as the data of the first AI model 126. In this scenario, the ecostudy module 110 analyzes the plurality of code changes based on the rule-based code inspection 128 within the rules inspection and AI module 125. In particular, the rule-based code inspection 128 within the rules inspection and AI module 125 includes a plurality of factors such as a profile of the user, a person who committed a code change, a frequency of the commit, a number of files committed, a number of changes in each of the files committed, a number of changes in each of the files committed, a number of configuration, supporting, build, and docket files, etc., of the plurality of code change inputs to identify the pipeline stages that need to be executed. In aspects of the present invention, the commit comprises a message that describes code changes made, providing context and justification for the update of the codes changes. In further embodiments, each of the plurality of factors may correspond with a specific user-defined weight. Accordingly, the ecostudy module 110 analyzes the plurality of codes changes based on a plurality of weighted factors to identify the pipelines states that need to be executed. The rule-based code inspection 128 may also be user configured to add additional factors or remove factors from the rules inspection and AI module 125.

In further aspects of the present invention, the ecostudy module 110 utilizes the first AI model 126 within the rules inspection and AI module 125 in response to the plurality of code change inputs being within the predetermined threshold similarity as the data of the first AI model 126. In this scenario, the ecostudy module 110 analyzes the plurality of code changes based on the first AI module 126 within the rules inspection and AI module 125. In particular, the first AI module 126 within the rules inspection and AI module 125 includes other plurality of factors such as commit comments, code review comments, etc., of the plurality of code change inputs to classify the plurality of code change inputs into categories, such as a defect fix, enhancement, re-factoring, maintenance, code clean up, unit test cases, cosmetic changes, adding comments, etc. In further embodiments, the first AI module 126 is trained to classify the plurality of code change inputs into the categories using a large language module (LLM) such as ChatGPT, Electra, GPT-Neo, etc. Further details of the first AI module 126 will be described in FIG. 5.

In embodiments of the present invention, the ecostudy module 110 utilizes a second AI model 127 (as shown in FIG. 5) within the rules inspection and AI module 125 to analyze the classified plurality of code change inputs. In particular, the ecostudy module 110 analyzes the classified plurality of code change inputs to determine an impact of a code change and evaluate dependencies of the code change on other modules within a codebase to identify the pipelines states that need to be executed. In further embodiments, the second AI module 127 is trained to identify the pipeline stages that need to be executed based on the classified plurality of code change inputs using a large language module (LLM) such as Bloom, Electra, Roberta, etc. In aspects of the present invention, the ecostudy module 110 utilizes the second AI model 127 to identify the pipeline stages that need to be executed and also eliminates (e.g., skip or prevent execution) the pipelines stages that do not need to be executed for the classified plurality of code change inputs. Accordingly, the ecostudy module 110 minimizes computing resource consumption (e.g., compute cycles) to reduce a carbon emission footprint by eliminating unneeded pipeline stages. In further embodiments, the ecostudy module 110 sends the identified pipeline stages that need to be executed and the pipelines stages that do not need to be executed for the classified plurality of code change inputs to the ecoflow module 115. Further details of the second AI module 127 will be described in FIG. 5.

In embodiments of the present invention, the ecoflow module 115 receives the identified pipeline stages that need to be executed and the pipelines stages that do not need to be executed for the classified plurality of code change inputs and utilizes a third AI module 129 (as shown in FIG. 5) of the rules inspection and AI module 125 to determine whether to initiate an approval workflow or execute the identified pipeline stages based on various contextual data. In further embodiments, the ecoflow module 115 utilizes the third AI module 129 to determine whether to initiate the approval workflow or the execution of the identified pipeline stages based on various contextual data such as a number of times a decision was approved for a similar previous pipeline execution scenario, a comparison of criticality of previous similar code change, usage patterns of the carbon footprint ecovision system 100, and commit user profiles for approval rates. For example, the ecoflow module 115 utilizes the third AI module 129 to determine to initiate the approval workflow in response to the pipeline stages that do not need be executed affecting a highly critical part of an application (e.g., user authentication) based on the highly critical part of the application being affected for a similar previous pipeline execution scenario. In embodiments, a similar pipeline execution scenario is determined based on the code similarity between the plurality of code changes and a similar pipeline execution scenario being above a predetermined. In an example, the predetermined similarity code threshold represents a percentage of code similarity between different code changes (e.g., between the plurality of code changes and a similar pipeline execution scenario). In further embodiments, the ecoflow module 115 initiates the approval workflow which requires a subject matter expert (SME), an end user, or an administrator to confirm approval of executing the identified pipeline stages that need to be executed and preventing execution of the pipelines stages that do not need to be executed. In other embodiments, the SME, the end user, or the administrator may deny the approval workflow which prevents execution of the identified pipeline stages that need to be executed. In another example, the ecoflow module 115 utilizes the third AI module 129 to determine to execute the identified pipeline stages and prevent execution of the pipeline stages that do not need to be executed in response to the pipeline stages that do not need to be executed having a low-risk impact and the similar previous pipeline execution scenario also having the low-risk impact. In aspects of the present invention, the third AI module 129 is trained to determine whether to initiate an approval workflow or execute the identified pipeline stages based on the various contextual data (e.g., previous pipeline executions, criticality of previous similar code change, usage patterns, and commit user profiles) using a large language module (LLM) such as Electra, Roberta, Palm2, etc. Accordingly, the third AI module 129 implements continuous learning based on previous and historical data. In another embodiment, the third AI module 129 may also be trained with other contextual data, such as a list of non-critical applications, minimum viable product development, stabilized products with minimal and known code changes, etc. Further details of the third AI module 129 will be described in FIG. 5. The ecoflow module 115 sends the identified pipeline stages that need to be executed and the pipelines stages that do not need to be executed to the ecorun module 120 in response to either approval of the approval workflow or determining to execute the identified pipeline stages based on various contextual data and prevention of execution of the pipelines stages that do not need to be executed.

In aspects of the present invention, the ecorun module 120 receives the identified pipeline stages that need to be executed and the pipelines stages that do not need to be executed and executes the identified pipeline stages that need to executed and prevents execution of the pipeline stages that do not need to be executed. Further, the ecorun module 120 generates critical data to calculate an environmental, social, and governance (ESG) score. In embodiments, the ecorun module 120 generates and saves the critical data including saved computing cycles, underlying infrastructure/environment resources mapped for each pipeline stage, etc. The ecorun module 120 calculates the ESG score to quantify the carbon footprint savings based on the critical data such as the saved computing cycles, average energy consumption per unit time utilized for each infrastructure/environmental resource, etc. The ecorun module 120 also generates a graphical user interface (GUI) which visualizes the saved computing cycles with respect to the time for the pipeline stages that need to be executed. The ecorun module 120 also shares the critical data with external tools and/or systems for calculating the ESG score. In embodiments of the present invention, the ecorun module 120 outputs carbon footprint outputs comprising the critical data and the ESG score.

FIG. 5 shows a block diagram of a rules inspection and an artificial intelligence (AI) model in accordance with aspects of the present invention. In FIG. 5, the rules inspection and AI module 125 comprises the first AI model 126, the second AI model 127, the rule-based code inspection 128, and the third AI model 129. In an example, the first AI model 126 identifies a comment such as “optimized database queries for faster performance” as an enhancement requiring stages such as build, test, and deploy. In another example, the first AI model 126 classifies a developer comment (e.g., “added security patch for login) as a bug fix to ensure that the build, text, vulnerability scan, and deploy stages are executed. In this situation, the first AI model 126 determines required pipeline stages to be executed to ensure a code change is effective. In aspects of the present invention, the first AI model 126 performs natural language processing (NLP) on the commits and parses the commits to classify a type of code change.

In aspects of the present invention, the second AI model 127 analyzes code snippets to understand an impact of the code change, evaluates dependencies of the code change with other modules within the codebase, and suggests which pipeline stages need to be executed to ensure all appropriate functions and modules are rebuilt, tested, deployed, validated, etc. As an example, the second AI model 127 determines that a shared utility function is modified by a code change, identifies other modules that rely on the shared utility function, and ensures that those stages which depend on the identified other modules are executed while skipping other stages that are not impacted by the shared utility function. In this scenario, the execution of the pipeline stages are optimized and creates energy savings. The second AI module 127 analyzes code snippets to ensure that code changes with a significant impact are caught early.

In further embodiments of the present invention, the third AI model 129 performs context driven analysis with historical data such as previous decisions, success rates for similar code changes in a similar situation on a similar list of files and modules. As an example, the third AI model 129 recommends triggering an approval workflow in response to a code change affecting a critical part of the application. In another example, the third AI model 129 recommends execution of the pipeline stages in response to a code change being a low-risk or repetitive change. The third AI model 129 ensure that the most critical pipeline stages (e.g., Build, Test, and Deploy) are executed while other stages (e.g., Scan) are not required and therefore are skipped.

In aspects of the present invention, the first AI model 126 and the second AI model 127 are fine-tuned on much smaller and specific datasets for specific tasks (e.g., text summarization, sentiment analysis, code review, etc.) than other conventional AI models which are trained on large datasets of code changes. Accordingly, the first AI model 126 and the second AI model 127 are trained only on smaller and specific required datasets. Thus, since the first AI model 126 and the second AI model 127 are trained on smaller and specific required datasets, the training of the first AI model 126 and the second AI model 127 results in faster inference, requires fewer compute cycles, less memory, and reduces the carbon footprint and energy consumption. Also, since the first AI model 126 and the second AI model 127 are trained on smaller and specific datasets, fewer cloud resources are utilized and the hardware infrastructure can utilize less power. In this scenario, energy is conserved and operation costs are reduced.

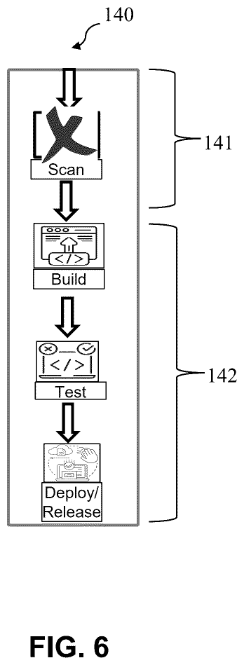

FIG. 6 shows an example of a pipeline of the carbon footprint ecovision system in accordance with aspects of the present invention. FIG. 6 shows the pipeline 140 which comprises the identified pipeline stages that need to be executed 142 and the pipeline stages that don't need to be executed 141. Accordingly, the ecorun module 120 in FIG. 4 executes the pipeline 140 which includes the identified pipeline stages that need to be executed 142 and does not execute the pipeline stages that don't need to be execute 141.

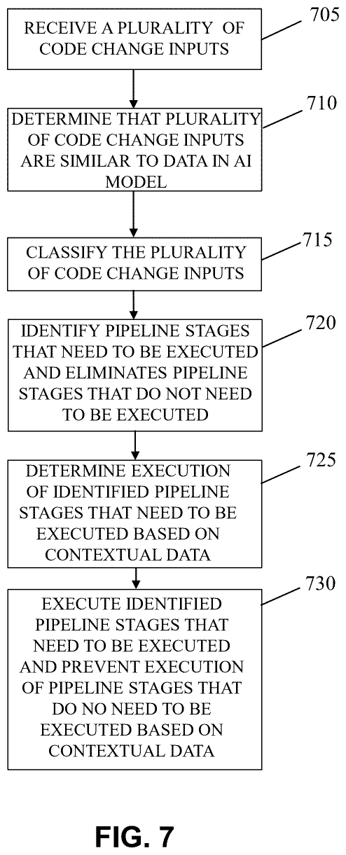

FIG. 7 shows a flowchart of an exemplary method of the quantum risk assessment system in accordance with aspects of the present invention. Steps of the method may be carried out in the carbon footprint ecovision environment 105 of FIG. 4.

At step 705, the system receives, at the ecostudy module 110, a plurality of code change inputs. In embodiments and as described with respect to FIG. 4, the ecostudy module 110 automatically receives the plurality of code changes based on a software developer making code changes.

At step 710, the system determines, at the ecostudy model 110, that the plurality of code changes are similar to data in the first AI model 126. In embodiments and as described with respect to FIG. 4, the ecostudy module 110 determines that the plurality of code changes are similar to data in the first AI model 126 in response to the plurality of code changes being within a predetermined threshold of the data in the first AI model 126.

At step 715, the system classifies, at the ecostudy model 110, the plurality of code changes. In embodiments and as described with respect to FIG. 4, the ecostudy module 110 classifies the plurality of code changes based on the trained first AI model 126.

At step 720, the system identifies, at the ecostudy module 110, pipelines stages that need to be executed and eliminates pipeline stages that do not need to be executed. In embodiments and as described with respect to FIG. 4, the ecostudy module 110 sends the identified pipelines stages that need to be executed and the identified pipeline stages that do not need to be executed to the ecoflow module 115.

At step 725, the system determines, at the ecoflow module 115, execution of the identified pipeline stages that need to be executed based on contextual data. In embodiments and as described with respect to FIG. 4, the ecoflow module 115 determines the identified pipelines stages that need to be executed based on contextual data such as a number of times a decision was approved for a similar previous pipeline execution scenario, a comparison of criticality of previous similar code changes, usage patterns, and commit user profiles for approved rules.

At step 730, the system executes, at the ecorun module 120, the identified pipeline stages that need to be executed and prevents execution of the pipeline stages that do not need to be executed. In embodiments and as described with respect to FIG. 4, the ecorun module 120 generates critical data and an ESG score to quantify the carbon footprint savings based on the critical data.

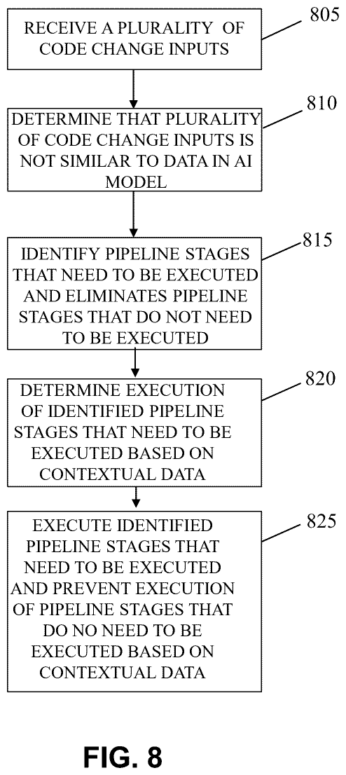

FIG. 8 shows a flowchart of an exemplary method of the carbon footprint ecovision system in accordance with aspects of the present invention. Steps of the method may be carried out in the carbon footprint ecovision environment of FIG. 4.

At step 805, the system receives, at the ecostudy module 110, a plurality of code change inputs. In embodiments and as described with respect to FIG. 4, the ecostudy module 110 automatically receives the plurality of code changes based on a software developer making code changes.

At step 810, the system determines, at the ecostudy model 110, that the plurality of code changes are not similar to data in the first AI model 126. In embodiments and as described with respect to FIG. 4, the ecostudy module 110 determines that the plurality of code changes are not similar to data in the first AI model 126 in response to the plurality of code changes being outside a predetermined threshold of the data in the first AI model 126.

At step 815, the system identifies, at the ecostudy module 110, pipelines stages that need to be executed and eliminates pipeline stages that do not need to be executed. In embodiments and as described with respect to FIG. 4, the ecostudy module 110 identifies the identified pipelines stages that need to be executed and the pipeline stages that do not need to be executed based on a rule-based inspection.

At step 820, the system determines, at the ecoflow module 115, execution of the identified pipeline stages that need to be executed based on contextual data. In embodiments and as described with respect to FIG. 4, the ecoflow module 115 determines the identified pipelines stages that need to be executed based on contextual data such as a number of times a decision was approved for a similar previous pipeline execution scenario, a comparison of criticality of previous similar code changes, usage patterns, and commit user profiles for approved rules.

At step 825, the system executes, at the ecorun module 120, the identified pipeline stages that need to be executed and prevents execution of the pipeline stages that do not need to be executed. In embodiments and as described with respect to FIG. 4, the ecorun module 120 generates critical data and an ESG score to quantify the carbon footprint savings based on the critical data.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, a plurality of code change inputs;
determining, by the computing device, that the plurality of code change inputs are similar to data in a first artificial intelligence (AI) model;
classifying, by the computing device, the plurality of code change inputs using a second AI model;
identifying, by the computing device, at least one pipeline stage that needs to be executed and at least one pipeline stage that does not need to be executed;
determining, by the computing device, that the identified at least one pipeline stage needs to be executed based on contextual data;
executing, by the computing device, the identified at least one pipeline stage that needs to be executed; and
preventing executing, by the computing device, the identified at least one pipeline stage that does not need to be executed.

2. The computer-implemented method of claim 1, wherein the determining that the plurality of code change inputs are similar to the data in the first AI model occurs in response to determining that the plurality of code change inputs are within a predetermined threshold of the data in the first AI model.

3. The computer-implemented method of claim 1, wherein the classifying the plurality of code change inputs using the second AI model comprises classifying the plurality of code change inputs into a category.

4. The computer-implemented method of claim 1, wherein the determining that the identified at least one pipeline stage needs to be executed based on the contextual data occurs in response to determining that the identified at least one pipeline stage was approved for a similar previous pipeline execution scenario as the identified at least one pipeline stage.

5. The computer-implemented method of claim 1, wherein the determining that the identified at least one pipeline stage needs to be executed based on the contextual data occurs in response to determining that the identified at least one pipeline stage has a same criticality as a similar previous pipeline execution scenario.

6. The computer-implemented method of claim 5, wherein the same criticality comprises a low-impact risk.

7. The computer-implemented method of claim 1, wherein the identifying the at least one pipeline stage that needs to be executed comprises identifying the at least one pipeline stage that needs to be executed based on an impact of the plurality of code change inputs and an evaluation of dependencies of the plurality of code change inputs on other modules within a codebase.

8. The computer-implemented method of claim 7, wherein the evaluation of the dependencies of the plurality of code change inputs on other modules within the codebase includes identifying the other modules within the codebase which rely on a same function as a function impacted by the plurality of code change inputs.

9. The computer-implemented method of claim 1, wherein the identifying the at least one pipeline stage that does not need to be executed comprises identifying the at least one pipeline stage that does not need to be executed based on an impact of the plurality of code change inputs and an evaluation of dependencies of the plurality of code change inputs on other modules within a codebase.

10. The computer-implemented method of claim 9, wherein the impact of the plurality of code change inputs comprises a low impact.

11. The computer-implemented method of claim 1, wherein the preventing execution of the identified at least one pipeline stage that does not need to be executed reduces compute cycles and a carbon footprint by skipping execution of the identified at least one pipeline stage that does not need to be executed.

12. A computer program product comprising one or more computer readable storage media having program instructions collectively stored on the one or more computer readable storage media, the program instructions executable to:
receive a plurality of code change inputs;
determine that the plurality of code change inputs are not similar to data in a first artificial intelligence (AI) model;
identify at least one pipeline stage that needs to be executed and at least one pipeline stage that does not need to be executed;
determine that the identified at least one pipeline stage needs to be executed based on contextual data;
execute the identified at least one pipeline stage that needs to be executed; and
prevent execution of the identified at least one pipeline stage that does not need to be executed.

13. The computer program product of claim 12, wherein the program instructions executable to determine that the plurality of code change inputs are not similar to the data in the first AI model occurs in response to program instructions executable to determine that the plurality of code change inputs are not within a predetermined threshold of the data in the first AI model.

14. The computer program product of claim 12, wherein the program instructions executable to determine that the at least one pipeline stage needs to be executed based on the contextual data occurs in response to program instructions executable to determine that the identified at least one pipeline stage was approved for a similar previous pipeline execution scenario as the identified at least one pipeline stage.

15. The computer program product of claim 12, wherein the program instructions executable to determine that the at least one pipeline stage needs to be executed based on the contextual data comprises program instructions executable to determine that the identified at least one pipeline stage has a same criticality as a similar previous pipeline execution scenario.

16. The computer program product of claim 15, wherein the same criticality comprises a low-impact risk.

17. The computer program product of claim 12, wherein the program instructions executable to identify the at least one pipeline stage that needs to be executed comprises program instructions executable to identify the at least one pipeline stage that needs to be executed based on an impact of the plurality of code change inputs and an evaluation of dependencies of the plurality of code change inputs on other modules within a codebase.

18. The computer program product of claim 17, wherein the evaluation of the dependencies of the plurality of code change inputs on other modules within the codebase includes identifying the other modules within the codebase which rely on a same function as a function impacted by the plurality of code change inputs.

19. The computer program product of claim 12, wherein the program instructions executable to identify the at least one pipeline stage that does not need to be executed comprises program instructions executable to identify the at least one pipeline stage that does not need to be executed based on an impact of the plurality of code change inputs and an evaluation of dependencies of the plurality of code change inputs on other modules within a codebase.

20. A system comprising:
a processor, a computer readable memory, one or more computer readable storage media, and program instructions collectively stored on the one or more computer readable storage media, the program instructions executable to:
receive a plurality of code change inputs;
determine that the plurality of code change inputs are similar to data in a first artificial intelligence (AI) model;
classify the plurality of code change inputs using a second AI model;
identify at least one pipeline stage that needs to be executed and at least one pipeline stage that does not need to be executed;
determine that the identified at least one pipeline stage needs to be executed based on contextual data;
execute the identified at least one pipeline stage that needs to be executed; and
prevent execution of the identified at least one pipeline stage that does not need to be executed.
